(19) United States
(12) Patent Application Publication
(10) Pub. No.: US 2005/0043035 A1
(43) Pub. Date: Feb. 24, 2005

(54) Method and apparatus for providing multimedia broadcast multicast service data to a subscriber to a multimedia broadcast multicast service

(76) Inventors: Michael J. Diesen, Vernon Hills, IL (US); Zhijun Cai, N. Richland Hills, TX (US); Jean-Aicard Fabien, Lincolnshire, IL (US)

Correspondence Address: MOTOROLA, INC., 1303 EAST ALGONQUIN ROAD, IL01/3RD, SCHAUMBURG, IL, 60196, US

(21) Appl. No.: 10/914,662

(22) Filed: Aug. 9, 2004

Related U.S. Application Data
(60) Provisional application No. 60/496,769, filed on Aug. 21, 2003.

(51) Int. Cl. H04B 7/00; H04M 11/00; H04Q 7/20; H04N 7/16; H04H 7/00; H04N 7/173

(52) U.S. Cl. 455/454; 725/62; 455/403; 725/131; 370/310

(57) ABSTRACT

A communication system conveys Multimedia Broadcast Multicast Service (MBMS) data to multiple mobile stations (MSs) subscribing to an MBMS service while minimizing possible congestion over an Iub interface. A network controller receives at least one MBMS data packet comprising an MBMS payload. In response to receiving the at least one data packet, the network controller establishes communication channels to the multiple MSs for conveyance of MBMS data and conveys to a downstream network element, via an Iub interface, a single copy of the payload. The downstream network element replicates the received payload to produce a copy of the payload for each established communication channel. The downstream network element then assembles, in association with each established communication channel, a set of one or more data packets for conveyance via the established communication channel, wherein each set of data packets includes a copy of the payload.

### CROSS-REFERENCE(S) TO RELATED APPLICATION(S)

The present application claims priority from provisional application Ser. No. 60/496,769, entitled “METHOD AND APPARATUS FOR PROVIDING MULTIMEDIA BROADCAST MULTICAST SERVICE DATA TO A SUBSCRIBER TO A MULTIMEDIA BROADCAST MULTICAST SERVICE,” filed Aug. 21, 2003, which is commonly owned and incorporated herein by reference in its entirety.

### FIELD OF THE INVENTION

The present invention relates generally to packet data communication systems, and, in particular, to a Multimedia Broadcast Multicast Service in a packet data communication system.

### BACKGROUND OF THE INVENTION

The Universal Mobile Telecommunication Service (UMTS) standard provides a compatibility standard for cellular mobile telecommunications systems. The UMTS standard ensures that a mobile station (MS), or user equipment (UE), operating in a UMTS system can obtain communication services when operating in a system manufactured according to the standard. To ensure compatibility, radio system parameters and data transfer procedures are specified by the standard, including protocols governing digital control messages and bearer traffic that are exchanged over an air interface.

The UMTS Release 6 standards provide, in 3GPP TS 22.146 (Third Generation Partnership Project Technical Specification 22.146), 3GPP TS 23.246, and 3GPP TS 25.346, for a provision of a Multimedia Broadcast Multicast Service (MBMS) service by a UMTS communication system to MSs serviced by the system and subscribed to the service. For example, FIG. 1 is a block diagram of an exemplary UMTS communication system 100 that provides an MBMS service to multiple MSs 102-104 (three shown) subscribed to the service in accordance with the prior art. When an MBMS content provider 138, such as a web-based server, has MBMS data for conveyance to subscribers to the service, such as MSs 102-103, the MBMS content provider 138 conveys the MBMS data to a Serving GPRS Support Node (SGSN) 130 via a data network 136, such as the Internet, a Broadcast Multicast Service Controller (BM-SC) 134, and a Gateway GPRS Support Node (GGSN) 132. SGSN 130 then makes a copy of the MBMS data for each RNC serving a subscribed MS 102-104 and routes the MBMS data to a Radio Network Controller (RNC) 112, 122 serving each of subscribed MSs 102-104 for conveyance of the data to the MSs.

In response to receiving the MBMS data from SGSN 130, each RNC 112, 122 then determines whether to establish a Point-To-Multipoint (PTM) communication channel or Point-To-Point (PTP) communication channels to the subscribed MSs 102-104 serviced by the RNC and a corresponding Node B 110, 120, typically a base transceiver station (BTS). The determination of whether to establish a PTM communication channel or PTP communication channels is based on a count, by the RNC, of a number subscribed MSs serviced by the RNC and corresponding Node B.

In order to count the number subscribed MSs serviced by the RNC and a corresponding Node B, each RNC 110, 112 broadcasts an MBMS notification to the MSs serviced by the RNC and Node B. The notification typically includes a Service Identifier associated with the MBMS service. In response to receiving the MBMS notification, each subscribed MS 102-104 conveys a connection request, typically a Radio Resource Control (RRC) connection establishment request, to the RNC 112, 122 serving the MS via an access channel and a serving Node B 110, 120. Based upon a number of connection requests received by each RNC 112, 122, the RNC determines whether to establish a PTM communication channel or PTP communication channels to the responding MS serviced by the RNC. Each RNC 112, 122 then sets up a communication session by establishing the PTM communication channel or PTP communication channels.

When multiple PTP communication channels are established by an RNC, the RNC makes a separate copy of the MBMS data for conveyance over each established communication channel. The RNC then conveys each copy of the data, in a data packet format comprising a payload and a header, in a separate data stream to a serving Node B. For example, when RNC 112 establishes a PTP communication channel with each of MSs 102 and 103, RNC 112 makes a separate copy of the MBMS data for each established PTP communication channel. RNC 112 then conveys each copy of the data, in a data packet format comprising a copy of the payload and a header, in a separate data stream to Node B 110

As a result, multiple, redundant copies of the payload are streamed over an Iub interface between RNC 112 and source Node B 110. Since bandwidth over the Iub interface is limited and can be a constraining factor in system performance, the transfer of redundant copies of data in multiple data streams over this interface can create undesirable, and performance limiting, congestion.

Furthermore, when multiple subscribed MSs serviced by a first RNC and a first Node B, such as MSs 102 and 103 that are served by RNC 112, and Node B 110, move to a cell that is serviced by a second RNC and a second Node B, such as RNC 122 and Node B 120, and are handed off to the second RNC and second Node B, the second RNC 122 determines whether to establish a PTM communication channel or PTP communication channels to the handed off MSs and other subscribed MSs, such as MS 104, serviced by the second RNC. When the second RNC 122 determines to establish PTP communication channels to the handed off MSs, MBMS data that was conveyed to the handed off MSs via first RNC 112 and first Node B 110 is rerouted to the MSs via first RNC 112, second RNC 122 and an Iur interface, and second Node B 120 and an Iub interface. That is, the MBMS data intended for the handed off MSs is still routed to first RNC 112, but instead of conveying the data to the MSs via first Node B 110, the first RNC 112 conveys the data to the MSs via the second RNC 122 and the second Node B 120.

As a result, the handoff of the multiple subscribed MSs from a first Node B 110 to a second Node B 120 can result in a streaming of multiple redundant copies of data, intended for each of the handed off MSs, via multiple data streams over an Iur interface between first RNC 112 and second RNC 122 and an Iub interface between second RNC 122 and second Node B 120. This is in addition to data streams transferred over the Iub interface between second RNC 122 and second Node B 120 and intended for the MS 104 already serviced by the second Node B. As bandwidth over the Iur and Iub interfaces is limited and can be a constraining factor in system performance, the transfer of redundant copies of data in multiple data streams over these interfaces can again create undesirable, and performance limiting, congestion.

Therefore, a need exists for a method and apparatus for reducing congestion of the Iub and Iur interfaces resulting from transfers of redundant copies of MBMS data to MSs subscribed to an MBMS service.

### BRIEF DESCRIPTION OF THE DRAWINGS

FIG. 1 is a block diagram of an exemplary wireless communication system of the prior art.

FIG. 2 is a block diagram of a wireless communication system in accordance with an embodiment of the present invention.

FIG. 3 is a block diagram of a Node B of FIG. 2 in accordance with an embodiment of the present invention.

FIG. 4 is a block diagram of a Radio Network Controller of FIG. 2 in accordance with an embodiment of the present invention.

FIG. 5 is a logic flow diagram of a method executed by the communication system of FIG. 2 to provide Multimedia Broadcast Multicast Service (MBMS) data to mobile stations in accordance with an embodiment of the present invention.

FIG. 6 is a block diagram of a wireless communication system in accordance with another embodiment of the present invention.

FIG. 7A is a logic flow diagram of method executed by the communication system of FIG. 6 to convey Multimedia Broadcast Multicast Service (MBMS) data to mobile stations that are actively engaged in an MBMS communication session as a result of a handoff of one or more of the mobile stations from a source Node B, and an associated source Radio Network Controller (RNC), to a target Node B, and an associated target RNC, in accordance with another embodiment of the present invention.

FIG. 7B is continuation of the logic flow diagram of FIG. 7A depicting a method executed by the communication system of FIG. 6 to convey Multimedia Broadcast Multicast Service (MBMS) data to mobile stations that are actively engaged in an MBMS communication session mobile stations as a result of a handoff of one or more of the mobile stations from a source Node B, and an associated source Radio Network Controller (RNC), to a target Node B, and an associated target RNC, in accordance with another embodiment of the present invention.

FIG. 7C is continuation of the logic flow diagrams of FIGS. 7A and 7B depicting a method executed by the communication system of FIG. 6 to convey Multimedia Broadcast Multicast Service (MBMS) data to mobile stations that are actively engaged in an MBMS communication session mobile stations as a result of a handoff of one or more of the mobile stations from a source Node B, and an associated source Radio Network Controller (RNC), to a target Node B, and an associated target RNC, in accordance with another embodiment of the present invention.

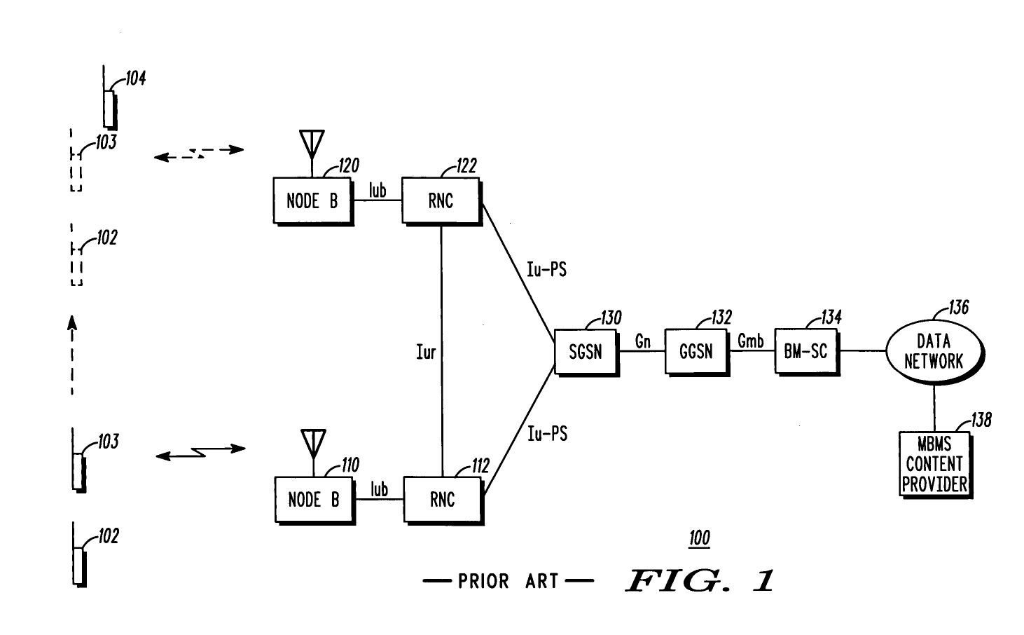

### DETAILED DESCRIPTION OF THE INVENTION

To address the need for a method and an apparatus for reducing congestion of the Iub and Iur interfaces resulting from transfers of redundant copies of Multimedia Broadcast Multicast Service (MBMS) data to mobile stations (MSs) subscribed to an MBMS service, a communication system is provided that provides for conveyance of MBMS data to multiple MSs subscribing to an MBMS service while minimizing possible congestion over an Iub interface. A network controller receives at least one MBMS data packet comprising an MBMS payload. In response to receiving the at least one MBMS data packet, the network controller establishes communication channels to the multiple subscribed MSs for conveyance of MBMS data and conveys to a downstream network element, via an Iub interface, a single copy of the MBMS payload. The downstream network element replicates the received MBMS payload to produce a copy of the MBMS payload for each communication channel established to one or more of the multiple subscribed MS. The downstream network element then assembles, in association with each established communication channel, a set of one or more data packets for conveyance via the established communication channel to one or more of the subscribed MSs, wherein each set of data packets comprises a copy of the MBMS payload.

Generally, an embodiment of the present invention encompasses a method for providing MBMS data to a mobile station (MS) subscribing to an MBMS service. The method includes receiving, by a network controller, at least one MBMS data packet comprising an MBMS payload and a header associated with the mobile station and, in response to receiving the at least one MBMS data packet, conveying, by the network controller to a downstream network element, multiple data packets wherein a first data packet of the multiple data packets comprises the MBMS payload and does not include the header associated with the mobile station and a second data packet of the multiple data packets comprises at least a portion of the header associated with the MS and does not include the MBMS payload.

Another embodiment of the present invention encompasses a method for providing MBMS data to multiple mobile stations (MSs) subscribing to an MBMS service. A network controller receives at least one MBMS data packet comprising an MBMS payload and, in response to receiving the at least one MBMS data packet, establishes multiple communication channels to the multiple MSs for conveyance of MBMS data. The network controller conveys a single copy of the MBMS payload to a downstream network element and the downstream network element replicates the MBMS payload to produce multiple copies of the MBMS payload. The downstream network element assembles a first data packet for conveyance to one or more of the multiple MSs via a first communication channel of the multiple communication channels, wherein the first data packet comprises at least a portion of a first copy of the MBMS payload of the multiple copies of the MBMS payload, and assembles a second data packet for conveyance to one or more of the multiple MSs via a second communication channel of the multiple communication channels, wherein the second data packet comprises at least a portion of a second copy of the MBMS payload of the multiple copies of the MBMS payload.

Yet another embodiment of the present invention encompasses a method for providing Multimedia Broadcast Multicast Service (MBMS) data to multiple MSs subscribing to an MBMS service. The method includes receiving, by a first network controller, at least one MBMS data packet comprising an MBMS payload, establishing, by a second network controller, multiple communication channels for conveyance of MBMS data to multiple MSs, and conveying, by the first network controller to the second network controller, a single copy of the MBMS payload for conveyance to the multiple MSs. The method further includes conveying, by the second network controller to a downstream network element, a single copy of the MBMS payload and replicating, by the downstream network element, the MBMS payload to produce multiple copies of the MBMS payload. The method further includes assembling, by the downstream network element, a first data packet for conveyance to one or more of the multiple MSs via a first communication channel of the multiple communication channels, wherein the first data packet comprises at least a portion of a first copy of the MBMS payload of the multiple copies of the MBMS payload, and assembling, by the downstream network element, a second data packet for conveyance to one or more of the multiple MSs via a second communication channel of the multiple communication channels, wherein the second data packet comprises at least a portion of a second copy of the MBMS payload of the multiple copies of the MBMS payload.

Still another embodiment of the present invention encompasses a network controller having a processor that receives at least one MBMS data packet comprising an MBMS payload and a header and, in response to receiving at least one MBMS data packet, conveys a multiple data packets wherein a first data packet of the multiple data packets comprises the MBMS payload and a second data packet of the multiple data packets comprises at least a portion of the header without the MBMS payload.

Yet another embodiment of the present invention encompasses a network controller having a processor that receives at least one MBMS data packet comprising an MBMS payload, establishes multiple communication channels for conveyance of the MBMS data to multiple MSs, and conveys to a downstream network element a single copy of the MBMS payload for conveyance to the multiple MSs via the multiple communication channels.

Still another embodiment of the present invention encompasses a Node B comprising a processor that receives multiple data packets, wherein a first data packet of the plurality of data packets comprises a MBMS payload and a second data packet of the multiple data packets comprises at least a portion of a header associated with an MS subscribing to an MBMS service and does not include a copy of the MBMS payload, and assembles a data packet for conveyance to the MS that comprises the payload and at least a portion of the received header.

Yet another embodiment of the present invention encompasses a Node B comprising a processor that receives MBMS payload, replicates the MBMS payload to produce multiple copies of the MBMS payload, assembles a first data packet for conveyance to a first MS via a first communication channel, wherein the first data packet comprises at least a portion of a first copy of the MBMS payload of the multiple copies of the MBMS payload, and assembles a second data packet for conveyance to a second MS via a second communication channel, wherein the second data packet comprises at least a portion of a second copy of the MBMS payload of the multiple copies of the MBMS payload.

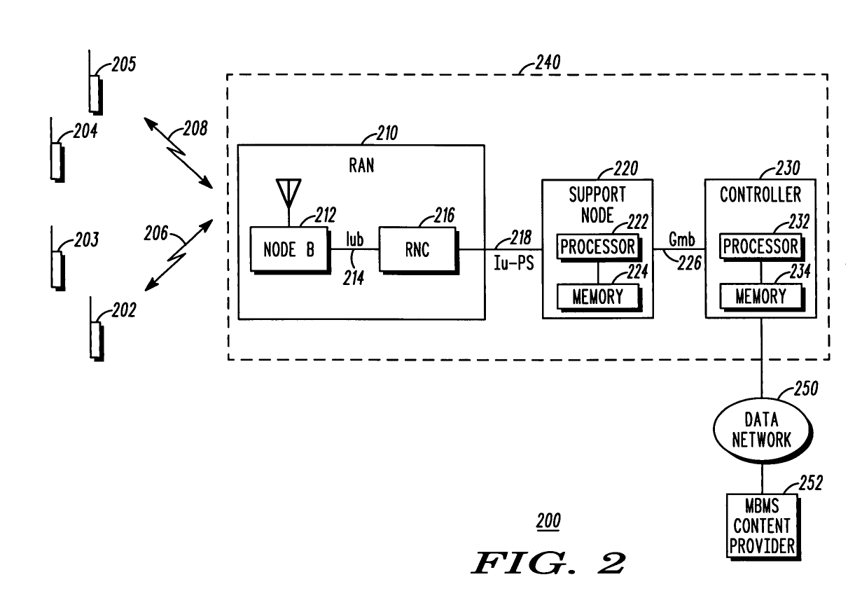

The present invention may be more fully described with reference to FIGS. 2-7C. FIG. 2 is a block diagram of a wireless communication system 200 in accordance with an embodiment of the present invention. Communication system 200 includes a Radio Access Network (RAN) 210 that includes at least one Node B 212, preferably a base transceiver station (BTS), that is downstream from, and operably coupled to, a Radio Network Controller (RNC) 216 via an Iub interface 214. Communication system 200 further includes a support node 220 upstream from, and operably coupled to, RAN 210, and in particular to RNC 216, via an Iu-PS interface 218, and an MBMS controller 230, preferably a Broadcast Multicast Service Controller (BM-SC), upstream from, and operably coupled to, support node 220 via a Gmb interface 226. Support node 220 typically includes one or more Serving 3G-GPRS Support Nodes (SGSNs) that are each coupled to one or more 3G-Gateway GPRS Support Nodes (GGSNs). However, the precise architecture of support node 220 is up to an operator of communication system 200 and is not critical to the present invention. Each of Node B 212, RNC 216, support node 220, and MBMS controller 230 may be referred to as a network entity and may further be collectively referred to as a wireless infrastructure 240.

Node B 212 provides communications services to mobile stations located in a coverage area of one or more coverage areas, such as a cell or geographic sectors of a cell, serviced by the Node B via one of multiple air interfaces 206, 208. Each air interface 206, 208 comprises a downlink and an uplink that each includes multiple communication channels. Preferably, the downlink includes a paging channel, at least one downlink control channel, and at least one downlink traffic channel. Preferably, the uplink includes an uplink access channel, at least one uplink control channel, and at least one uplink traffic channel.

Communication system 200 further includes multiple mobile stations (MSs), or user equipment (UEs), 202-205 (four shown), such as but not limited to a cellular telephone, a radio telephone, a personal digital assistant (PDA) or a laptop computer with radio frequency (RF) capabilities, or a wireless modem that provides RF access to portable digital terminal equipment (DTE) such as a laptop computer. Each MS of the multiple MSs 202-205 is provided wireless communication services by Node B 212. Each MS of MSs 202-205 may be co-located in a same coverage area serviced by Node B 212, or one or more of MSs 202-205 may be located in a coverage area serviced by Node B 212 and different than a coverage area of other MSs of the multiple MSs 202-205.

Each MS of the multiple MSs 202-205 subscribes to, that is, is associated with a user that subscribes to, a Multimedia Broadcast Multicast Service (MBMS) service provided by communication system 200, which service provides for a distribution of MBMS data to the MSs. MBMS services are described in detail in the Release 6 3GPP (Third Generation Partnership Project) standards, and in particular 3GPP TS (Technical Specification) 22.146, 3GPP TS 23.246, 3GPP TS 25.346, which specifications and reports are hereby incorporated by reference herein and copies of wnich may be obtained from the 3GPP via the Internet or from the 3GPP Organization Partners' Publications Offices at Mobile Competence Centre 650, route des Lucioles, 06921 Sophia-Antipolis Cedex, France.

Each of support node 220 and MBMS controller 230 includes a respective processor 222, 232 such as one or more microprocessors, microcontrollers, digital signal processors (DSPs), combinations thereof or such other devices known to those having ordinary skill in the art. Each of support node 220 and controller 230 further includes a respective one or more memory devices 224, 234 associated with the respective processor, such as random access memory (RAM), dynamic random access memory (DRAM), and/or read only memory (ROM) or equivalents thereof, that store data and programs that may be executed by the processor and allow the processor to operate in communication system 200. The one or more memory devices 234 of MBMS controller 230 further maintain a mobile identifier (mobile ID) associated with each MS 202-205 subscribing to the MBMS service and a Service Identifier (Service ID) associated with the MBMS service subscribed to by the MSs.

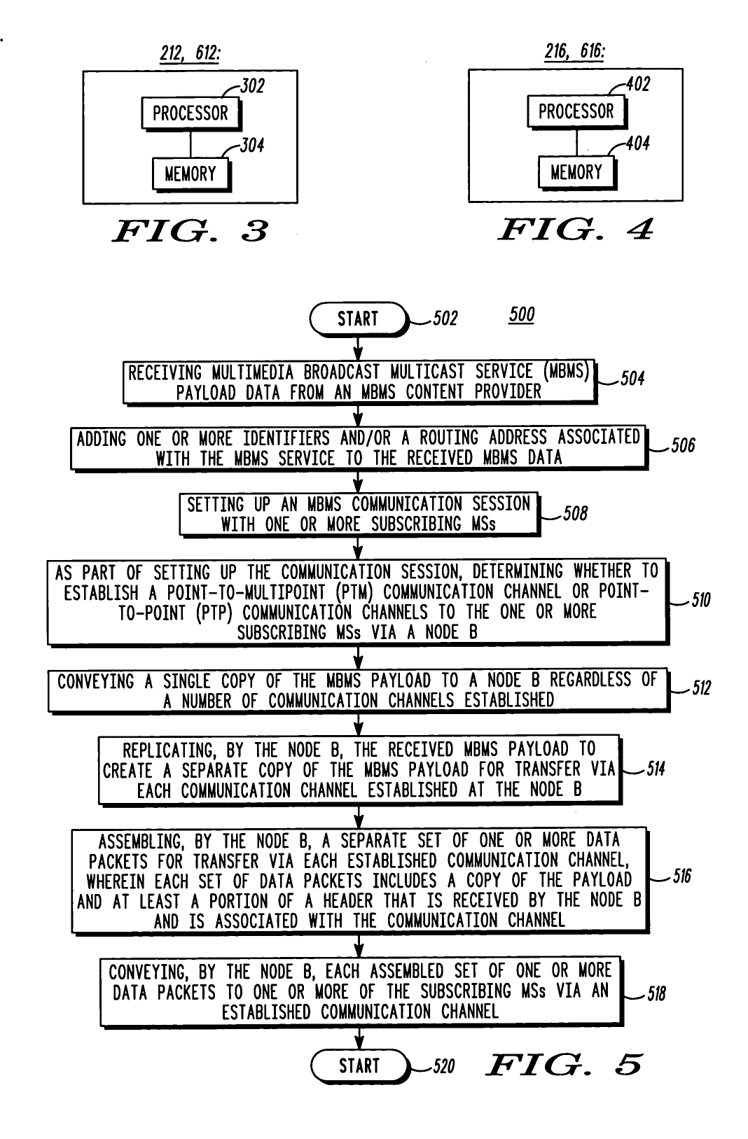

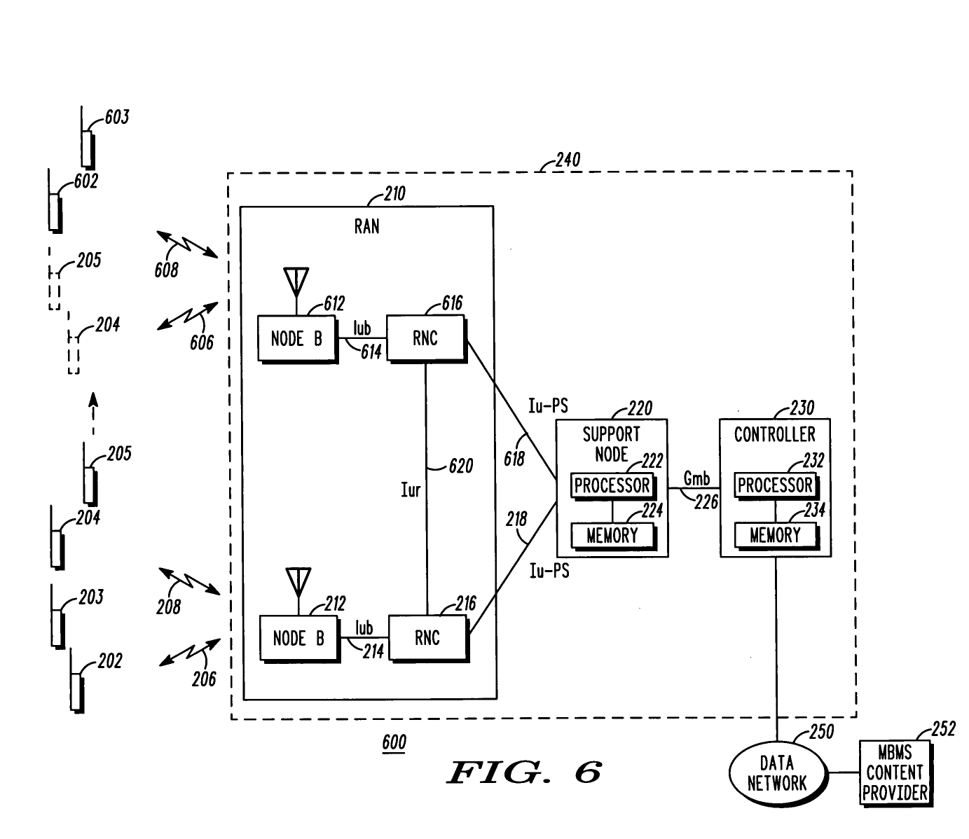

Referring now to FIGS. 3 and 4, Node B 212 and RNC 216 each includes a respective processor 302, 402 such as one or more microprocessors, microcontrollers, digital signal processors (DSPs), combinations thereof or such other devices known to those having ordinary skill in the art. Node B 212 and RNC 216 further includes a respective one or more memory devices 304, 404 associated with the respective processor, such as random access memory (RAM), dynamic random access memory (DRAM), and/or read only memory (ROM) or equivalents thereof, that store data and programs that may be executed by the processor and allow the processor to operate in communication system 200.

Preferably, communication system 200 is a Universal Mobile Telecommunication Service (UMTS) communication system that operates in accordance with the 3GPP (Third Generation Partnership Project) standards, which provide a compatibility standard for UMTS air interfaces and which standards are hereby incorporated herein in their entirety. The standards specify wireless telecommunications system operating protocols, including radio system parameters and call processing procedures. In communication system 200, the communication channels of the downlink and uplink of each of air interfaces 206 and 208, such as access channels, control channels, paging channels, and traffic channels, each comprises one or more of multiple time slots in a same frequency bandwidth. However, those who are of ordinary skill in the art realize that communication system 200 may operate in accordance with any wireless telecommunication system, such as but not limited to a General Packet Radio Service (GPRS) communication system, a Code Division Multiple Access (CDMA) 2000 communication system, a Time Division Multiple Access (TDMA) communication system, or an Orthogonal Frequency Division Multiple Access (OFDM) communication system.

Communication system 200 further includes a Multimedia Broadcast Multicast Service (MBMS) content provider 252, such as an Internet Protocol (IP) multicast server, that is coupled to infrastructure 240, and in particular to MBMS controller 230, via a data network 250, such as an IP network. As part of the MBMS service subscribed to by each of MSs 202-205, MBMS content provider 252 sources MBMS data, typically in the form of IP data packets, to MSs 202-205 via MBMS controller 230, support node 220, and a RAN 210.

In order to preserve bandwidth and limit system congestion, communication system 200 provides for a reduction of a number of redundant copies of MBMS data transferred over Iub interface 214. By reducing a quantity of MBMS data transferred over the Iub interface, communication system 200 is able to preserve a capacity of the interface for transfer of MBMS data and is further able to reduce the congestion of the interface and thereby avoid potential MBMS data bottlenecks that may result from provision of data from multiple MBMS content providers to subscribers to MBMS services.

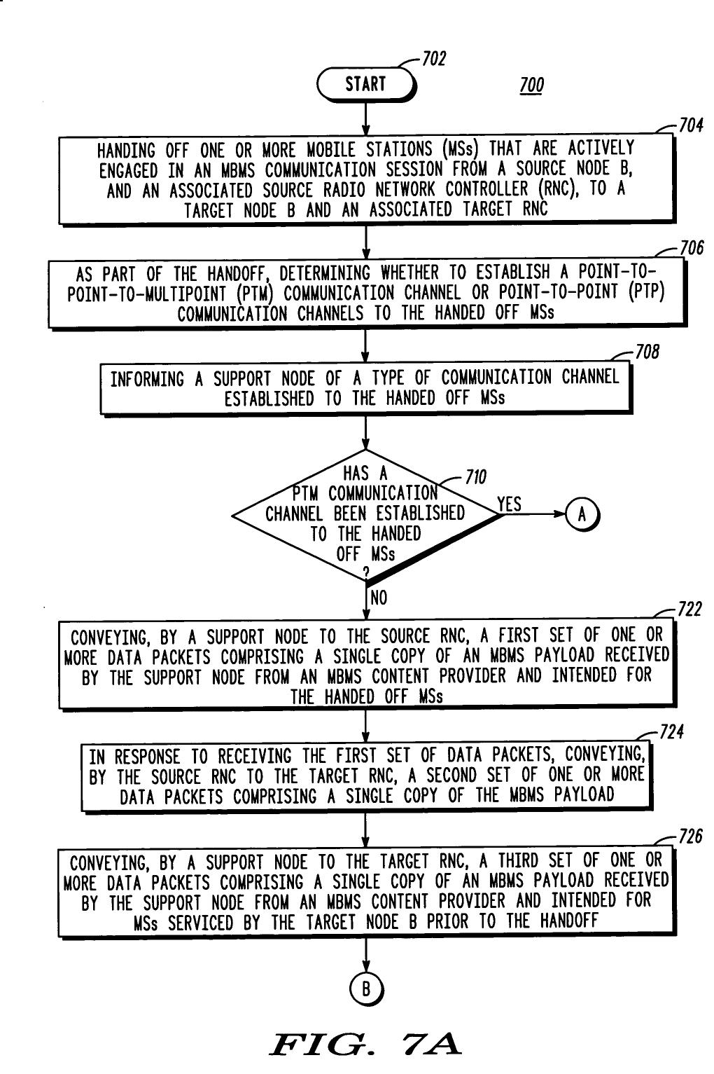

FIG. 5 is a logic flow diagram 500 of a method executed by communication system 200 to provide MBMS data to MSs 202-205 in accordance with an embodiment of the present invention. Logic flow diagram 500 begins (502) when infrastructure 240 receives (504) an MBMS payload, typically in one or more Internet Protocol (IP) data packets that each comprises at least a portion of the payload and a header, from MBMS content provider 252 via data network 250. Typically, the header of the IP data packets includes a routing address, such as an IP address, associated with the MBMS content provider. When the payload is conveyed via multiple data packets, each data packet may further include a packet sequence number that indicates an order of the data packets.

Infrastructure 240 routes the MBMS data packets to MBMS controller 230. MBMS controller 230 then adds (506), to a header of each data packet, the Service ID associated with the MBMS service to the data packets and/or a routing address, such as an IP address, associated with MBMS content provider 252. Controller 230 may further add to the headers of the data packets a sequence identifier (sequence ID) or a session identifier (session ID) that indicates an order of the data packets. Controller 230 then conveys the data packets, including the added identifiers, to support node 220 and the support node forwards a copy of the MBMS data packets to RNC 216 via Iu-PS interface 218. In response to the receiving the MBMS data packets, RNC 216 sets up (508) an MBMS communication session with each MS 202-205 that is currently serviced by the RNC and that is subscribed to the MBMS service. Unless otherwise specified herein, the functions performed herein by each of Node B 212, RNC 216, support node 220, and controller 230 are respectively performed by processor 302 of the Node B, processor 402 of the RNC, processor 222 of the support node, and processor 232 of the controller.

In setting up the MBMS communication session, RNC 216 determines (510) whether to establish a Point-To-Multipoint (PTM) communication channel or one or more Point-To-Point (PTP) communication channels to subscribed MSs 202-205 co-located in a coverage area. As is known in the art, RNC 216 determines whether to establish a PTM communication channel or PTP communication channels to each MS 202-205 based on a count, by the RNC, of a number of MSs subscribing to the MBMS service and co-located in a same coverage area serviced by Node B 212. For example, RNC 216 may establish a PTM communication channel when the RNC determines that more than five (5) subscribed MSs are co-located in a coverage area, and may establish a PTP communication channel when the RNC determines that five (5) or fewer subscribed MSs are co-located in a coverage area. However, the threshold used to determine whether to establish a PTM communication channel or PTP communication channels is up to a designer of communication system 200 and is not critical to the present invention. RNC 216 then establishes the determined PTM and/or PTP communication channels.

In the prior art communication system 100, in response to establishing the communication channel(s), an RNC such as RNC 112 makes a separate copy of the MBMS payload for each established communication channel and conveys to a Node B, in separate data packets and via separate data streams, a separate copy of the MBMS data for each established communication channel. This may result in a forwarding of multiple copies of the payload to the Node B. In order to preserve bandwidth and reduce system congestion, RNC 216 conveys (512) a single copy of the MBMS payload data to Node B 212 via Iub interface 214 regardless of a number of communication channels established at the Node B.

In one embodiment of the present invention, in conveying a single copy of the MBMS data to Node B 212, RNC 216 may simply forward to the Node B a copy of the data packets received from support node 220. In another embodiment of the present invention, RNC 216 may convey to Node B 212 modified versions of the data packets received from support node 220. In one such embodiment of the present invention, RNC 216 may delete the MBMS payload from each MBMS data packet received from support node 220 and leave the payload portion of the data packet blank or replace it with a dummy payload. In this manner, RNC 216 may create ‘header’ data packets that merely convey the headers received from support node 220. RNC 216 may then create separate ‘payload’ data packets in which the RNC embeds a single copy of the MBMS payload and to which the RNC attaches a generic header. In another such embodiment of the present invention, RNC 216 may strip the header off of each MBMS data packet received from support node 220 and add a new, generic header the data packet, thereby creating ‘payload’ data packets that merely convey a single copy of the MBMS payload received from support node 220. RNC 216 may then create separate ‘header’ data packets to which the RNC adds a copy of the header received with each data packet from support node 220. RNC 216 then conveys the ‘header’ data packets and the ‘payload’ data packets to Node B 212.

For example, suppose that support node 220 conveys the MBMS payload to RNC 216 in three (3) data packets. Furthermore, suppose that a first PTM communication channel is established to MSs 202 and 203 and a second PTM communication channel is established to MSs 204 and 205. In prior art communication system 100, an RNC such as RNC 112 would make a separate copy of the MBMS payload for each established communication channel and convey to Node B 110 two copies of the payload in six (6) data packets. By contrast, in one embodiment of the present invention, RNC 216 merely forwards a single copy of the three data packets to Node B 212. In another embodiment of the present invention, RNC 216 may convey six (6) data packets to Node B 212, that is, a first set of three (3) ‘payload’ data packets that include a single copy of the payload and a second set of three (3) ‘header’ data packets. Each data packet of the second set of data packets includes at least a portion of a header of a data packet received by the RNC. For example, RNC 216 may create the second set of ‘header’ data packets by merely deleting the payload from each of the three (3) data packets. RNC 216 may further replace the deleted payload of each ‘header’ data packet with dummy data or leave at least a portion of the data packet empty. Notwithstanding the conveyance of a same number of data packets to a Node B as in the prior art, system 200 capacity is preserved as each data packet in the second set of data packets includes less data, and may be a considerably smaller data packet, than the data packets received by RNC 216.

In still another embodiment of the present invention, RNC 216 may convey a reduced set of headers with respect to the headers received from support node 220, along with one copy of the payload, to Node B 212. As the headers of each MBMS data packet received from support node 220 may be substantially redundant of each other, RNC may convey fewer than all of headers received from the support node. For example, again suppose that support node 220 conveys the MBMS payload to RNC 216 in three (3) data packets. The headers of the three data packets may be nearly identical except for a different sequence number and perhaps a few other values. RNC 216 may then forward a single copy of the payload to Node B 212 in a first set of three (3) ‘payload’ data packets and may forward a single version of the header in a second set of one (1) ‘header’ data packet.

In response to receiving the one or more data packets from RNC 216, Node B 212 replicates (514) the payload included in the one or more data packets, such as in the ‘payload’ data packets, to create a separate copy of the payload for transfer over each established communication channel. For example, when a first PTM communication channel is established to MSs 202 and 203 and a second PTM communication channel is established to MSs 204 and 205, Node B 212 may replicate the payload to produce two (2) copies of the payload. By way of another example, when a PTM communication channel is established to MSs 202 and 203 and PTP communication channels are established to each of MSs 204 and 205, Node B may replicate the payload to produce three (3) copies of the payload.

Node B 212 then assembles (516) a separate set of data packets for transfer over each communication channel to the subscribed MS or MSs 202-205 associated with the communication channel. Each set of data packets assembled by Node B 212 includes a copy of the payload and at least a portion of a header received from RNC 216. In one embodiment of the present invention, wherein the ‘header’ data packets conveyed by RNC 216 to Node B 212 may include only a single header data packet in association with each established communication channel, Node B 212 may replicate each header received from RNC 216 when the MBMS payload requires multiple data packets in order to be conveyed over an established communication channel. For example, when the MBMS payload requires three (3) data packets for transfer over an established communication channel and only a single header is received in regard to the communication channel, Node B 212 may replicate at least a portion of the header to produce a header for each of the three data packets. Node B 212 may further add a sequence number to each such header. In another embodiment of the present invention, wherein RNC 216 creates the ‘header’ data packets by merely deleting the payload from each data packet received from RNC 216, Node B 212 may create each set of data packets for transfer over an established communication channel by merely embedding a copy of the payload, or at least a portion of a copy of the payload if the payload does not fit into a single data packet, into each received ‘header’ data packet.

Upon assembling a set of data packets for transfer via each established communication channels, wherein each set of data packets includes a separate copy of the MBMS payload, Node B 212 conveys (518) each set of data packets via the corresponding communication channel to the subscribed MS or MSs 202-205 associated with the communication channel. Logic flow diagram 500 then ends (520).

By conveying only a single copy of the MBMS payload to Node B 212 via Iub interface 214 regardless of a number of communication channels established to transfer MBMS data to subscribed MSs 202-205 serviced by the Node B, RNC 216 minimizes a number of copies of the payload transferred over the Iub interface. Node B 212 then replicates the received MBMS payload in order to produce separate copies of the payload for conveyance over each communication channel established to a subscribed MS 202-205 serviced by the Node B. By minimizing a number of copies of the payload transferred over the Iub interface, communication system 200 is able to preserve a capacity of the Iub interface and is further able to reduce congestion of, and minimize a potential for bottlenecks in, the interface.

As each of MSs 202-205 moves through communication system 200 while actively engaged in an MBMS communication session, the MS may be handed off from a source Node B, that is, Node B 212, to a target Node B. As part of the handoff procedure, an RNC associated with the target Node B determines whether to establish a PTM communication channel or PTP communication channels to the handed off MSs. In prior art communication system 100, when a target RNC 122 associated with a target Node B 120 determines to establish PTP communication channels with the handed off MSs 102, 103, a source RNC 112 (associated with a source Node B 110) subsequently conveys MBMS data to the target Node B, via the target RNC, in a separate data packet and via a separate data stream for each communication channel associated with a handed off MS. The payloads of the MBMS data packets separately conveyed for each communication channel associated with a handed off MS is the same, potentially resulting in a streaming of multiple redundant copies of data via multiple data streams over the interfaces between the source RNC and the target RNC and between the target RNC and the target Node B. The transfer of redundant copies of data in multiple data streams over these interfaces can create undesirable, and performance limiting, congestion and bottlenecks in the interfaces.

In order to minimize the congestion resulting from such a handoff and the potential for a bottleneck, another embodiment of the present invention provides a communication system that transfers a single copy of an MBMS payload over data routes established between RNCs and Node Bs as a result of a handoff. By transferring a single copy of the MBMS payload, congestion is reduced and bottlenecks may be avoided.

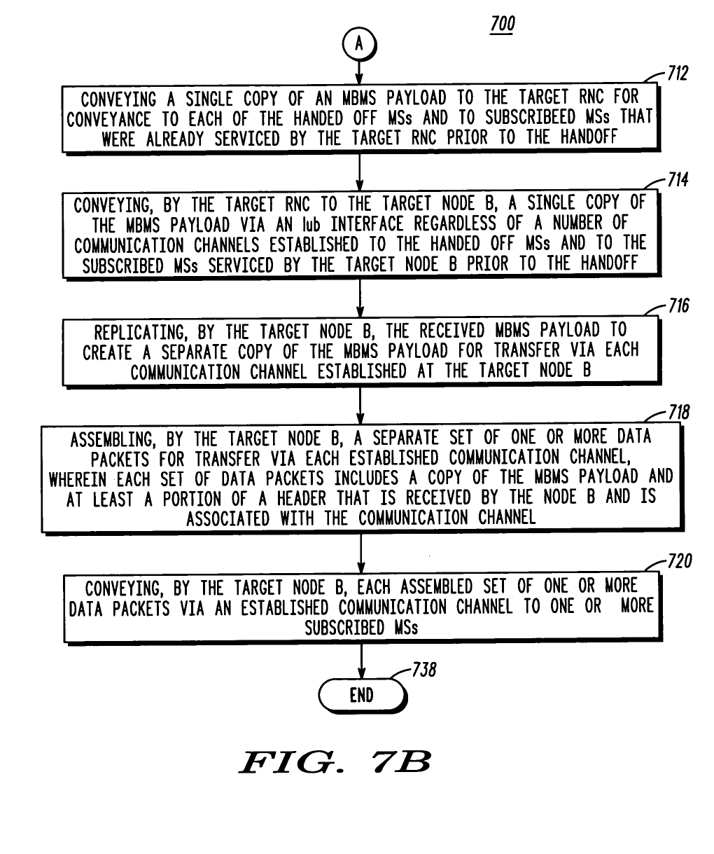

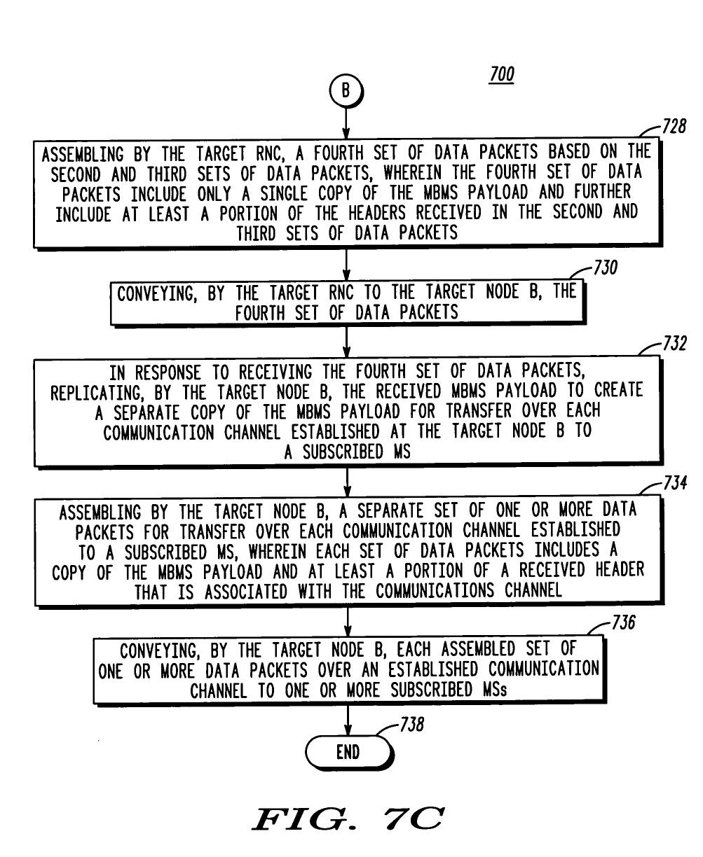

Referring now to FIGS. 6, 7A, 7B, and 7C, a wireless communication system 600 is illustrated that provides for a transfer of MBMS data to multiple MSs that are actively engaged in an MBMS communication session and are serviced by a target Node B, and an associated target RNC, as a result of handoff of at least one of the multiple MSs in accordance with another embodiment of the present invention. FIG. 6 is a block diagram of communication system 600 in accordance with another embodiment of the present invention. Communication system 600 is similar to communication system 200 except that RAN 210 further includes a target Node B 612 that is downstream from, and operably coupled to, a target, or drift, RNC 616 via an Iub interface 614. Target RNC 616 is further operably coupled to an upstream support node, that is, support node 220, via an Iu-PS interface 618 and to source RNC 216 by an Iur interface 620. Communication system 600 further includes, in addition to MSs 202-205, multiple MSs 602, 603 that also subscribe to the MBMS service and that are serviced by target Node B 612.

Target Node B 612 provides communications services to MSs located in one or more coverage areas, such as a cell or geographic sectors of a cell, serviced by the Node B via one of multiple air interfaces 606, 608. Each air interface 606, 608 comprises a downlink and an uplink that each includes multiple communication channels. Preferably, the downlink includes a paging channel, at least one downlink control channel, and at least one downlink traffic channel. Preferably, the uplink includes an uplink access channel, at least one uplink control channel, and at least one uplink traffic channel.

Referring now to FIGS. 3 and 4, similar to source Node B 212 and source RNC 216, target Node B 612 and target RNC 616 each includes a respective processor 302, 402 associated with, such as coupled to or including, a respective one or more memory devices 304, 404. Unless otherwise specified herein, the functions performed herein by each of Node B 612 and RNC 616 are respectively performed by processor 302 of the Node B and processor 402 of the RNC.

Referring now to FIGS. 7A, 7B, and 7C, a logic flow diagram 700 is depicted of method executed by communication system 600 in transferring MBMS data to multiple MSs that are actively engaged in an MBMS communication session and are serviced by a target Node B, and an associated target RNC, as a result of handoff of at least one of the multiple MSs in accordance with another embodiment of the present invention. Logic flow diagram 700 begins (702) when one or more of MSs 202-205, such as MSs 204 and 205, that are actively engaged in an MBMS communication session and serviced by a source Node B 212 and an associated source RNC 216, moves to a coverage area serviced by target Node B 612. In response to the movement of MSs 204 and 205, communication system 600 hands off (704) the MS from source Node B 212, and associated source RNC 216, to target Node B 612 and associated target, or drift, RNC 616. The procedures for handing off service of an MS from a source Node B to a target Node B are well known in the art and will not be described in detail herein. During the course of the handoffs of MSs 204, 205, target RNC 616 determines (706) whether to establish a Point-To-Multipoint (PTM) communication channel or Point-To-Point (PTP) communication channels to each of the handed off MSs 204, 205 based on a count, by the target RNC, of a quantity of MSs subscribed to the MBMS service and co-located with the handed off MSs in a coverage area serviced by target Node B 612 and associated target RNC 616.

In response to determining to establish a PTM communication channel or PTP communication channels to MSs 204 and 205, target RNC 616 informs (708) support node 220 of a type of communication channel(s) established to the handed off MSs. When a PTM communication channel is established (710) to MSs 204 and 205, support node 220 conveys (712) a single copy of an MBMS payload received from MBMS content provider 252 to target RNC 616 for conveyance to each of the handed off MSs 204, 205 and the subscribed MSs 602, 603 that were already serviced by target RNC 616 and target Node B 612 prior to the handoff.

Similar to the procedure described in greater detail above with respect to FIG. 5 and the conveyance of a single copy of MBMS payload data from RNC 216 to Node B 212, target RNC 616 then conveys (714), in one or more MBMS data packets, a single copy of the MBMS payload to target Node B 612 via Iub interface 614 regardless of a number of communication channels established at the Node B. Along with the single copy of the MBMS payload, target RNC 616 further conveys to target Node B 612 at least a portion of the headers of the MBMS data packets received from support node 220. As described in detail above with respect to FIG. 5 and the conveyance of a single copy of MBMS payload data from RNC 216 to Node B 212, the header(s) conveyed by target RNC 616 to target Node B 612 may be included in the same data packets as the MBMS payload or may be included in data packets separate from the data packets conveying the MBMS payload.

In response to receiving the MBMS payload and the header(s) from target RNC 616, and similar to step 514 as described above with respect to FIG. 5 and Node B 212, target Node B 612 replicates (716) the MBMS payload received from target RNC 616 to create a separate copy of the payload for transfer via each communication channel established to one or more of MSs 204, 205, 602, and 603. Similar to step 516 as described above with respect to FIG. 5 and Node B 212, target Node B 612 then assembles (718) a separate set of MBMS data packets for transfer over each communication channel established to one or more of subscribed MSs 204, 205, 602, and 603. Each set of MBMS data packets assembled by target Node B 612 includes a copy of the payload and at least a portion of the received header or headers associated with the MS or MSs. Upon assembling a set of MBMS data packets for transfer via each established communication channel, wherein each set of data packets includes a separate copy of the MBMS payload, target Node B 612 conveys (720) each set of MBMS data packets via the corresponding communication channel to the subscribed MS or MSs 204, 205, 602, 603 associated with the communication channel. Logic flow diagram 700 then ends (738).

When a PTP communication channel is established (710) to each of MSs 204 and 205, support node 220 conveys (722), to source RNC 216 for conveyance to each of the handed off MSs 204, 205, a first set of one or more MBMS data packets comprising a single copy of an MBMS payload received from MBMS content provider 252. Similar to the procedure described in greater detail above with respect to FIG. 5 and the conveyance of a single copy of MBMS payload data from RNC 216 to Node B 212, source RNC 216 then conveys (724), to target RNC 616 via Iur interface 620, in association with each of handed off MSs 204, 205 and regardless of a number of communication channels established to the handed off MSs 204, 205, a second set of one or more MBMS data packets comprising a single copy of the MBMS payload. Along with the single copy of the MBMS payload, source RNC 616 further conveys to target RNC 612 at least a portion of the headers received from support node 220 as part of the first set of one or more data packets, which headers are associated with the handed off MSs 204, 205. As described in detail above with respect to FIG. 5 and the conveyance of a single copy of MBMS payload data from RNC 216 to Node B 212, the header(s) conveyed by source RNC 216 to target RNC 616 may be included in the same data packets as the MBMS payload or may be included in data packets separate from the data packets conveying the MBMS payload. For example, in one embodiment of the present invention, the second set of MBMS data packets may be the same as the first set of MBMS data packets. However, in other embodiments of the present invention, the second set of MBMS data packets may be different than the first set of MBMS data packets, such as the second set of data packets comprising separate ‘payload’ data packets and ‘header’ data packets.

With respect to subscribed MSs 602, 603 serviced by target Node B 612 prior to the handoff of MSs 204 and 205, support node 220 conveys (726) to target RNC 616, via Iu-PS interface 618, a third set of one or more MBMS data packets comprising a single copy of an MBMS payload received from MBMS content provider 252 and further comprising one or more headers associated with the communication channels established to MSs 602 and 603. In response to receiving the second set of MBMS data packets from source RNC 216 via Iur interface 620 that are intended for transfer over each communication channel established to one or more of handed off MSs 204 and 205, and further in response to receiving the third set of MBMS data packets from support node 220 via Iu-PS interface 618 and intended for transfer over each communication channel established to one or more of MSs 602 and 603 serviced by Node B 612 prior to the handoff of MSs 204 and 205, target RNC 616 assembles (728), and conveys (730) to target Node B 612, a fourth set of MBMS data packets that are based on the second set of MBMS data packets and the third set of MBMS data packets and that provide for a conveyance of only a single copy of the MBMS payload and at least a portion of the headers received in the second set and third set of MBMS data packets, that is, headers associated with the communication channels established to MSs 204, 205, 602, and 603.

Similar to FIG. 5 and the conveyance of a single copy of the MBMS payload by RNC 216 to Node B 212, in one embodiment of the present invention, in conveying a single copy of the MBMS data to target Node B 612, target RNC 616 may convey to Node B 612 modified versions of the second set of MBMS data packets received from source RNC 216 and the third set of MBMS data packets received from support node 220. That is, in one embodiment of the present invention, target RNC 616 may delete the MBMS payload from each MBMS data packet received from source RNC 216 and support node 220 and leave the payload portion of the data packet blank or replace it with a dummy payload. In this manner, target RNC 616 may create ‘header’ data packets that merely convey the headers received from source RNC 216 and support node 220. Target RNC 616 may then create separate ‘payload’ data packets in which the RNC embeds a single copy of the MBMS payload and to which the RNC attaches a generic header. In another embodiment of the present invention, target RNC 616 may strip the header off of each MBMS data packet comprising MBMS payload data that is received as part of the second set of data packets from source RNC 216 or as part of the third set of data packets from support node 220 and add a new, generic header the data packet, thereby creating ‘payload’ data packets that merely convey a single copy of the MBMS payload received from source RNC 616 and support node 220. Target RNC 616 may then create separate ‘header’ data packets to which the RNC adds a copy of the header received with each data packet of the second set of data packets from source RNC 216 and the third set of data packets from support node 220. Target RNC 616 then conveys the ‘header’ data packets and the ‘payload’ data packets to target Node B 612.

For example, suppose that support node 220 conveys the MBMS payload in a set of three (3) data packets to source RNC 216 and another set of three (3) data packets to target RNC 616. Furthermore, suppose that PTP communication channels are established at target Node B 612 to each of MSs 204, 205, 602, and 603. Source RNC 216 may then convey a single copy of the MBMS payload to target RNC 616, along with headers associated with the three data packets received by source RNC 216 from support node 220. For example, source RNC 216 may forward to target RNC 616 the three (3) data packets received from support node 220, or source RNC 216 may assemble and convey to target RNC 616 a set of three (3) ‘payload’ data packets that include a copy of the payload and a set of one or more ‘header’ data packets that include at least a portion of the headers received from support node 220.

Upon receiving a copy of the MBMS payload from each of source RNC 216 and support node 220, target RNC 216 then conveys a single copy of the MBMS payload, along with at least a portion of the headers received from each of source RNC 216 and support node 220, to target Node B 612. For example, target RNC 616 may forward to target Node B 612 ‘payload’ data packets received from source RNC 216, or target RNC 616 may create three (3) ‘payload’ data packets, as described in detail above, based on the MBMS payload received from one of source RNC 216 and support node 220. Target RNC 616 further forwards to target Node B 612 headers associated with each communication channel established to subscribed MSs serviced by Node B 612, that is, MSs 204, 205, 602, and 603. The headers may be included in a set of ‘header’ data packets assembled by target RNC 616. In one embodiment of the present invention, the ‘header’ data packets may include ‘header’ data packets received from source RNC 216 and further include ‘header’ data packets that are assembled based on the MBMS data packets received from support node 220. For example, the ‘header’ data packets assembled based on the MBMS data packets received from support node 220 may be assembled by deleting the payload from each of the three (3) data packets received from the support node. By way of another example, when the headers received from support node 220 are substantially redundant of each other, the ‘header’ data packets assembled by target RNC 616 based on the MBMS data packets received from support node 220 may comprise a single ‘header’ data packet comprising a single version of the received headers.

In response to receiving the fourth set of MBMS data packets from target RNC 616, target Node B 612 replicates (732) the received MBMS payload to create a copy of the MBMS payload for transfer over each communication channel established to one or more of subscribed MSs 204, 205, 602, and 603. Target Node B 612 then assembles (734) a separate set of data packets for transfer via each communication channel established to one or more of subscribed MSs 204, 205, 602, and 603. Each set of data packets assembled by target Node B 612 includes a copy of the MBMS payload and further includes at least a portion of the received header or headers associated with a communication channel established to the one or more subscribed MSs 204, 205, 602, 603. For example, when target RNC 616 creates a set of ‘header’ data packets by merely deleting the payload from each data packet received from support node 220 and/or forwards to target Node B 612 ‘header’ data packets received from source RNC 216, target Node B 612 may create each set of data packets intended for an MS by embedding a copy of at least a portion of the MBMS payload back into each received ‘header’ data packet. Target Node B 612 then conveys (736) each set of data packets assembled by the Node B for transfer via an established communication channel to one or more subscribed MSs 204, 205, 602, 603 via the established communication channel, and logic flow diagram 700 ends (738).

By conveying only a single copy of the MBMS payload over each of Iur interface 620 and Iub interface 614 after MSs 204 and 205 are handed off from source Node B 212 to target Node B 612, regardless of a number of communication channels established at the target Node B to the handed off MSs 204, 205 and to the MSs 602, 603 serviced by the target Node B prior to the handoff, communication system 600 minimizes a number of copies of the payload transferred over each interface. Target Node B 612 then replicates the received MBMS payload in order to produce separate copies of the payload for conveyance over each communication channel established to a subscribed MS 204, 205, 602, 603 serviced by the target Node B. By minimizing a number of copies of the payload transferred over the Iur and Iub interfaces, communication system 600 is able to preserve a capacity of each of the Iur and Iub interfaces and is further able to reduce congestion of, and minimize a potential for bottlenecks in, the interfaces.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

1. A method for providing Multimedia Broadcast Multicast Service (MBMS) data to a mobile station subscribing to an MBMS service, the method comprising:
receiving, by a network controller, at least one MBMS data packet comprising an MBMS payload and a header associated with the mobile station; and
in response to receiving the at least one MBMS data packet, conveying, by the network controller to a downstream network element, a plurality of data packets wherein a first data packet of the plurality of data packets comprises the MBMS payload and does not include the header associated with the mobile station and a second data packet of the plurality of data packets comprises at least a portion of the header associated with the mobile station and does not include the MBMS payload.

2. The method of claim 1, further comprising assembling, by the downstream network element, a data packet for conveyance to the mobile station that comprises the Multimedia Broadcast Multicast Service (MBMS) payload and at least a portion of the header received from the network controller.

3. The method of claim 2, wherein the downstream network element comprises a Node B.

4. The method of claim 3, wherein the network controller comprises a first network controller and wherein conveying comprises:
conveying a first set of data packets by the first network controller to a second network controller, wherein a first data packet of the first set of data packets comprises the MBMS payload and a second data packet of the first set of data packets comprises at least a portion of the header received by the first network controller without the payload; and
conveying a second set of data packets by the second network controller to the Node B, wherein a first data packet of the second set of data packets comprises the MBMS payload and a second data packet of the second set of data packets comprises at least a portion of the header received from the first network controller without the payload.

5. The method of claim 4, wherein the Node B comprises a second Node B that is associated with the second network controller and wherein the method further comprises handing off the mobile station from a first Node B associated with the first network controller to the second Node B.

6. The method of claim 1, wherein the mobile station comprises a plurality of mobile stations and wherein receiving comprises receiving, by a network controller from a support node, at least one MBMS data packet comprising an MBMS payload and a header associated with the mobile station.

7. A method for providing Multimedia Broadcast Multicast Service (MBMS) data to a plurality of mobile stations subscribing to an MBMS service, the method comprising:
receiving, by a network controller, at least one MBMS data packet comprising an MBMS payload;
in response to receiving the at least one MBMS data packet, establishing a plurality of communication channels to the plurality of mobile stations for conveyance of MBMS data;
conveying, by the network controller to a downstream network element, a single copy of the MBMS payload;
replicating, by the downstream network element, the MBMS payload to produce a plurality of copies of the MBMS payload;
assembling, by the downstream network element, a first data packet for conveyance to one or more of the plurality of mobile stations via a first communication channel of the plurality of communication channels, wherein the first data packet comprises at least a portion of a first copy of the MBMS payload of the plurality of copies of the MBMS payload; and
assembling, by the downstream network element, a second data packet for conveyance to one or more of the plurality of mobile stations via a second communication channel of the plurality of communication channels, wherein the second data packet comprises at least a portion of a second copy of the MBMS payload of the plurality of copies of the MBMS payload.

8. The method of claim 7, wherein the network controller comprises a first network controller and the downstream network element comprises a first downstream network element and wherein the method further comprises:
handing off a first mobile station and a second mobile station of the plurality of mobile stations from the first downstream network element to a second downstream network element;
conveying, by the first network controller to a second network controller associated with the second downstream network element, a single copy of the MBMS payload;
conveying, by the second network controller to the second downstream network element, a single copy of the MBMS payload;
replicating, by the second downstream network element, the MBMS payload to produce a plurality of copies of the MBMS payload;
assembling, by the second downstream network element, a first data packet for conveyance to the first mobile station via a first communication channel, wherein the first data packet comprises at least a portion of a first copy of the MBMS payload of the plurality of copies of the MBMS payload; and
assembling, by the second downstream network element, a second data packet for conveyance to the second mobile station via a second communication channel, wherein the second data packet comprises at least a portion of a second copy of the MBMS payload of the plurality of copies of the MBMS payload.

9. The method of claim 7, wherein the network controller comprises a first network controller and the downstream network element comprises a first downstream network element, wherein the first network controller receives the MBMS payload from a support node, and wherein the method further comprises:
handing off a first mobile station and a second mobile station of the plurality of mobile stations from the first downstream network element to a second downstream network element;
receiving, by a second network controller associated with the second downstream network element from a support node, an MBMS payload intended for each of the first mobile station and the second mobile station;
conveying, by the second network controller to the second downstream network element, a single copy of the MBMS payload received by the second network element from the support node; and
assembling, by the second downstream network element, a data packet for conveyance to the first mobile station via a first communication channel, wherein the data packet comprises at least a portion of the MBMS payload.

10. The method of claim 7, wherein the network controller comprises a first network controller and the downstream network element comprises a first downstream network element, wherein the first network controller receives the MBMS payload from a support node, and wherein the method further comprises:
handing off a first mobile station and a second mobile station of the plurality of mobile stations from the first downstream network element to a second downstream network element;
receiving, by a second network controller associated with the second downstream network element from a support node, an MBMS payload intended for each of the first mobile station, the second mobile station, and a third mobile station that was serviced by the second downstream network element prior to the handoff of the first mobile station and the second mobile station to the second downstream network element;
establishing a plurality of communication channels for transfer of MBMS data from the second downstream network element to the first mobile station, second mobile station, and third mobile station;
conveying, by the second network controller to the second downstream network element, a single copy of the MBMS payload;
replicating, by the second downstream network element, the MBMS payload to produce a plurality of copies of the MBMS payload;
assembling, by the second downstream network element, a first data packet for conveyance to one or more of the first, second, and third mobile stations via a first communication channel of the plurality of communication channels established for transfer of MBMS data from the second downstream network element, wherein the first data packet comprises at least a portion of a first copy of the MBMS payload of the plurality of copies of the MBMS payload; and
assembling, by the second downstream network element, a second data packet for conveyance to one or more of the first, second, and third mobile stations via a second communication channel of the plurality of communication channels established for transfer of MBMS data from the second downstream network element, wherein the second data packet comprises at least a portion of a second copy of the MBMS payload of the plurality of copies of the MBMS payload.

11. A method for providing Multimedia Broadcast Multicast Service (MBMS) data to a plurality of mobile stations subscribing to an MBMS service, the method comprising:
receiving, by a first network controller, at least one MBMS data packet comprising an MBMS payload;
establishing, by a second network controller, a plurality of communication channels for conveyance of MBMS data to a plurality of mobile stations;
conveying, by the first network controller to the second network controller, a single copy of the MBMS payload for conveyance to the plurality of mobile stations;
conveying, by the second network controller to a downstream network element, a single copy of the MBMS payload;
replicating, by the downstream network element, the MBMS payload to produce a plurality of copies of the MBMS payload;
assembling, by the downstream network element, a first data packet for conveyance to one or more of the plurality of mobile stations via a first communication channel of the plurality of communication channels, wherein the first data packet comprises at least a portion of a first copy of the MBMS payload of the plurality of copies of the MBMS payload; and
assembling, by the downstream network element, a second data packet for conveyance to one or more of the plurality of mobile stations via a second communication channel of the plurality of communication channels, wherein the second data packet comprises at least a portion of a second copy of the MBMS payload of the plurality of copies of the MBMS payload.

12. A network controller comprising a processor that receives at least one Multimedia Broadcast Multicast Service (MBMS) data packet comprising an MBMS payload and a header and, in response to receiving at least one MBMS data packet, conveys a plurality of data packets wherein a first data packet of the plurality of data packets comprises the MBMS payload and a second data packet of the plurality of data packets comprises at least a portion of the header without the MBMS payload.

13. A network controller comprising a processor that receives at least one Multimedia Broadcast Multicast Service (MBMS) data packet comprising an MBMS payload, establishes a plurality of communication channels for conveyance of the MBMS data to a plurality of mobile stations, and conveys to a downstream network element a single copy of the MBMS payload for conveyance to the plurality of mobile stations via the plurality of communication channels.

14. The network controller of claim 13, wherein the downstream network element comprises a first downstream network element and wherein, when at least two mobile stations of the plurality of mobile stations are handed off to a second downstream network element that is serviced by a second network controller and a plurality of communication channels are established for conveyance of MBMS data to the at least two mobile stations by the second downstream network element, the processor conveys to a the second network controller a single copy of the MBMS payload for conveyance to the at least two mobile stations via the plurality of communication channels established for conveyance of MBMS data to the at least two mobile stations by the second downstream network element.

15. A Node B comprising a processor that receives a plurality of data packets, wherein a first data packet of the plurality of data packets comprises a Multimedia Broadcast Multicast Service (MBMS) payload and a second data packet of the plurality of data packets comprises at least a portion of a header associated with a mobile station subscribing to an MBMS service and does not include a copy of the MBMS payload, and assembles a data packet for conveyance to the mobile station that comprises the payload and at least a portion of the received header.

16. The node B of claim 15, wherein the mobile station comprises a first mobile station and a second mobile station, wherein the plurality of data packets received by the processor comprises a first data packet comprising a Multimedia Broadcast Multicast Service (MBMS) payload, a second data packet comprising a first header without the MBMS payload, and a third data packet comprising a second header without the MBMS payload, and wherein the processor assembles a data packet by replicating the MBMS payload to produce a plurality of copies of the MBMS payload and assembling a first data packet for conveyance to the first mobile station and a second data packet for conveyance to the second mobile station, wherein the first data packet comprises at least a portion of a first copy of the MBMS payload of the plurality of copies of the MBMS payload and further comprises at least a portion of the first header, and wherein the second data packet comprises at least a portion of a second copy of the MBMS payload of the plurality of copies of the MBMS payload and further comprises at least a portion of the second header.

17. A Node B comprising a processor that receives a Multimedia Broadcast Multicast Service (MBMS) payload, replicates the MBMS payload to produce a plurality of copies of the MBMS payload, assembles a first data packet for conveyance to a first mobile station via a first communication channel, wherein the first data packet comprises at least a portion of a first copy of the MBMS payload of the plurality of copies of the MBMS payload, and assembles a second data packet for conveyance to a second mobile station via a second communication channel, wherein the second data packet comprises at least a portion of a second copy of the MBMS payload of the plurality of copies of the MBMS payload.
